(19) United States
(12) Patent Application Publication
(10) Pub. No.: US 2013/0245988 A1
(43) Pub. Date: Sep. 19, 2013

(54) MACHINE FOR MOUNTING LEDS TO A CIRCUIT BOARD

(71) Applicant: CHIH-CHEN LAI, Tu-Cheng (TW)

(72) Inventor: CHIH-CHEN LAI, Tu-Cheng (TW)

(73) Assignee: HON HAI PRECISION INDUSTRY CO., LTD., Tu-Cheng (TW)

(21) Appl. No.: 13/556,226

(22) Filed: Jul. 24, 2012

(30) Foreign Application Priority Data
Mar. 16, 2012 (TW) 101108977

(51) Int. Cl. G06F 15/00

(52) U.S. Cl. 702/150

(57) ABSTRACT

A mounting machine for mounting LEDs on predetermined positions of a circuit board. The circuit board includes two positioning points. Each LED includes an optical identification point. The mounting machine includes a mounting area and a precise adjusting area located downstream of the mounting area and consisting of a sensor, a processing unit and an adjusting unit. The mounting machine places the LEDs on the circuit board. The precise adjusting area precisely adjusts the position of the LED to a predetermined position of the precise adjusting area finds that the LED is deviated from the predetermined position.

### BACKGROUND

1. Technical Field

The present disclosure relates to a mounting machine for mounting electronic components to a circuit board, and more particularly, to a mounting machine for mounting LEDs (light emitting diodes) to a circuit board with high precision.

2. Description of Related Art

Owing to many advantages, such as high luminosity, low operational voltage, low power consumption, compatibility with integrated circuits, easy driving, long term reliability, and environmental friendliness, LEDs have been widely promoted as a light source.

It needs to precisely place an LED on a predetermined position of a printed circuit board (PCB), whereby light from the LED can precisely illuminate a required object, such as a light guide of a backlight module. A conventional LED mounting machine is to provide an optical sensor, for example, a CCD (charge-coupled device) to check the profile of the LED thereby to find a center of the LED. To mount the LED to a circuit board, the LED is moved to the circuit board with the center of the LED aligned with a predetermined position of the circuit board. However, such a mounting technology cannot always precisely mount the LED to the circuit board at the predetermined position, due to measuring error of the profile of the LED and positioning error of moving the LED. For an optoelectronic component, such as LEDs, the precise positioning of the LEDs on their predetermined positions of the circuit board is essential.

Therefore, what is needed is a mounting machine for mounting LEDs on a circuit board which can overcome the above described shortcomings.

### BRIEF DESCRIPTION OF THE DRAWINGS

FIG. 1 is a diagrammatic view of a machine for mounting LEDs to a circuit board, in accordance with an exemplary embodiment of the present disclosure.

FIG. 2 is a diagrammatic view showing a precise adjustment of positions of LEDs on the circuit board.

FIG. 3 is a diagrammatic view showing the precise adjustment of the positions of LEDs on the circuit board from another aspect.

### DETAILED DESCRIPTION

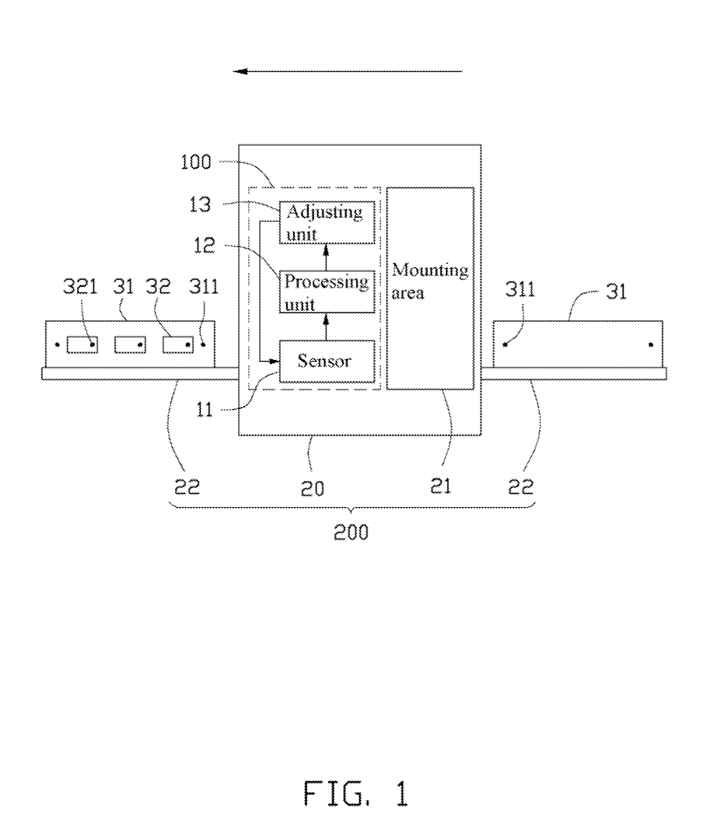

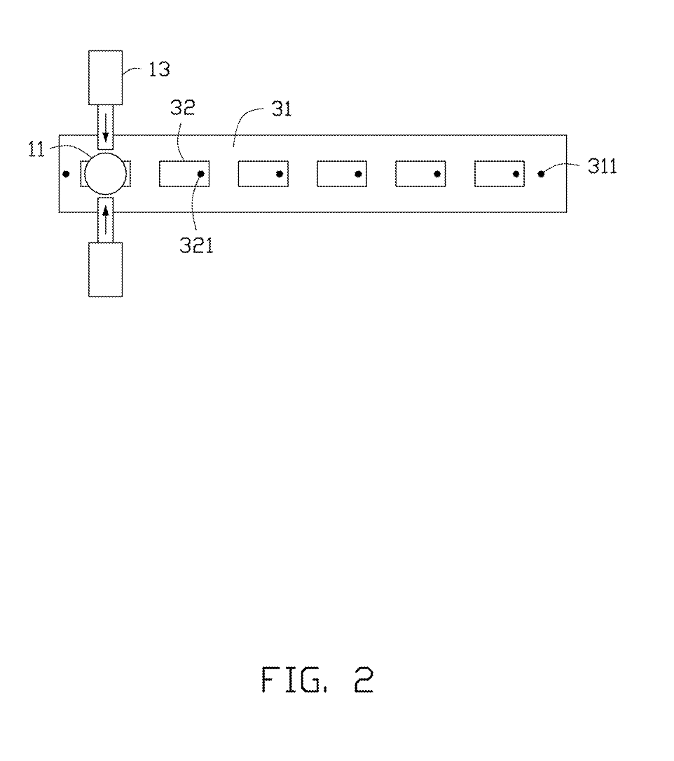

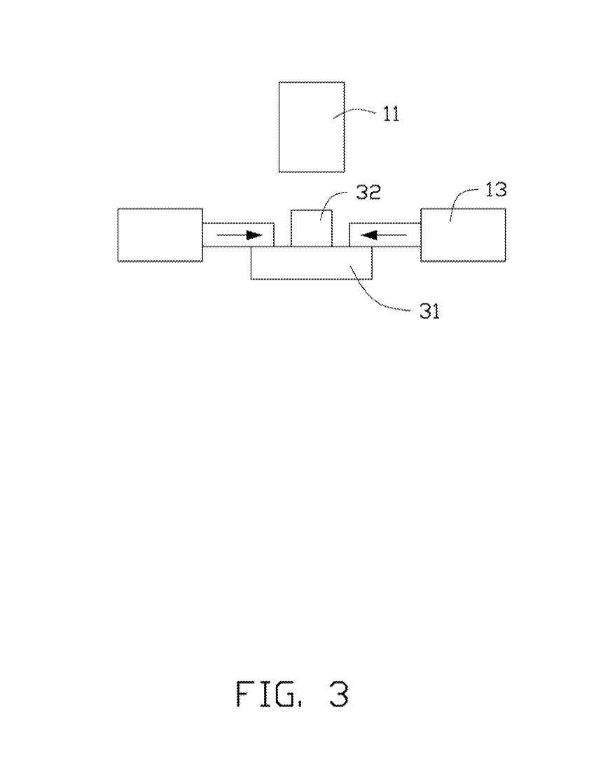

Referring to FIGS. 1-3, an exemplary embodiment of a mounting machine 200, in accordance with the present embodiment, is shown.

The mounting machine 200 includes a main body 20, a mounting area 21 arranged in the main body 20, a conveyer 22 extending through the main body 20, and a precise adjusting area 100 arranged in the main body 20 and located at a downstream side of the mounting area 21.

The precise adjusting area 100 is used to precisely adjust the positions of LEDs 32 to predetermined positions of a PCB 31. In the present embodiment, the PCB 31 has two positioning points 311 arranged on two opposite ends thereof, respectively. The LEDs 32 are arranged on the PCB 31 via the mounting machine 200. The LEDs 32 are first mounted on the PCB 31 via the mounting area 21 of the mounting machine 200, wherein the first mounting area 21 has a function like a conventional mounting machine, which mounts the LEDs 32 to the PCB 31 by detecting profiles of the LEDs 32 by an optical sensor such as a CCD. However, according to the present disclosure, each LED 32 further has an optical identification point 321 near an end thereof. Generally, the optical identification point 321 is formed on a top surface of the LED 32 when the LED 32 is manufactured.

The precise adjusting area 100 includes a sensor 11, a processing unit 12 and an adjusting unit 13.

The sensor 11 is used to detect the position of the positioning points 311 of the PCB 31 and the position of the optical identification point 321 of each LED 32. The sensor 11 is an optical sensor such as a charge-coupled device (CCD). In the present embodiment, the sensor 11 includes an image sensor with a magnification ranges from 50 times magnification to 100 times magnification. The image sensor catches images of the positioning points 311 of the PCB 31 and image of the optical identification point 321 of each LED 32 and then determines the position of the positioning points 311 and the optical identification point 321 according to the image.

The processing unit 12 receives the detected result from the sensor 11 and then compares the position of the optical identification point 321 of each LED 32 with the position of the positioning points 311 of the PCB 31; the processing unit 12 obtains the compared result and judges whether the LED 32 is deviated from its intended mounting position and the degree of the deviation if any. In the present embodiment, the two positioning points 311 of the PCB 31 each act as a reference point. When the optical identification point 321 of an LED 32 and the two positioning points 311 of the PCB 31 are in a straight line, it represents that the LED 32 is precisely arranged on the predetermined position to be mounted; therefore, it does not need to adjust the position of the LED 32 by the adjusting unit 13, and the adjusting unit 13 does not act on the LED 32. When the optical identification point 321 of the LED 32 and the two positioning points 311 of the PCB 31 are not in a straight line, it represents that the LED 32 is misplaced and needs to be adjusted by the adjusting unit 13.

The adjusting unit 13 receives the compared result from the processing unit 12, and selectively adjusts the position of the LED 32 according to the compared result. When the LED 32 is misplaced, the adjusting unit 13 adjusts the position of the LED 32 to make sure that the optical identification point 321 of the LED 32 and the two positioning points 311 of the PCB 31 are in a straight line. When the LED 32 is moved by the adjusting unit 13 to the predetermined position of the PCB 31, the adjusting unit 13 stops acting on the LED 32.

In the present embodiment, the sensor 11 can monitor the adjusted result from the adjusting unit 13 to see whether the adjusting unit 13 has moved the deviated LED 32 to its intended position precisely. The adjusting unit 13 can be a step motor or piezoelectric driver, which can precisely move the LED 32 to its intended position. The sensor 11 obtains a series of images of the LED 32 when the adjusting unit 13 adjusts the position of the LED 32, and transmits them to the processing unit 12. The processing unit 12 receives the images and judges whether the LED 32 is moved to the predetermined position, and asks the adjusting unit 13 to continue its adjustment if the LED 32 has not yet reached its intended precise mounting position. When the images of the LED 32 represent that the optical identification point 321 of the LED 32 and the two positioning points 311 of the PCB 31 are in a straight line, the processing unit 12 controls the adjusting unit 13 to stop working. When the images of the LED 32 represent that the optical identification point 321 of the LED 32 and the two positioning points 311 of the PCB 31 are not in a straight line, the processing unit 12 controls the adjusting unit 13 to continue work to adjust the position of the LED 32 until the LED 32 reaches the predetermined position.

In process of mounting the LEDs 32, the PCB 31 is arranged on the conveyer 22 of the mounting machine 200. The conveyer 22 drives the PCB 31 to the mounting area 21 wherein the LEDs 32 are mounted on the PCB 31; then the conveyer 22 transfer the PCB 31 together with the LEDs 32 to the precise adjusting area 100, wherein the precise adjusting area 100 adjusts the positions of LEDs 32, if necessary, to make sure that the LEDs 32 are all positioned on the predetermined positions, and at last the PCB 31 together with the LEDs 32 is driven out of the precise adjusting area 100 by the conveyer 22 to be ready to be processed by a downstream working station, which usually is a reflow oven for soldering the LEDs 32 to the PCB 31 by surface mounting technology (SMT). The precise adjusting area 100 has a simple structure, an easy operation, and can place the LEDs 32 on a predetermined position with high precision.

It is to be further understood that even though numerous characteristics and advantages have been set forth in the foregoing description of embodiments, together with details of the structures and functions of the embodiments, the disclosure is illustrative only; and that changes may be made in detail, especially in matters of shape, size, and arrangement of parts within the principles of the disclosure to the full extent indicated by the broad general meaning of the terms in which the appended claims are expressed.

What is claimed is:

1. A machine for mounting LEDs on predetermined positions of a circuit board, the circuit board comprising at least two positioning points, each LED comprising an optical identification point, the machine comprising:
a mounting area for placing the LEDs on the circuit board;
a precise adjusting area downstream the mounting area, comprising:
a sensor for detecting positions of the positioning points of the circuit board and a position of the optical identification point of each LED;
a processing unit receiving the detected result from the sensor, comparing the position of the optical identification point of each LED with that the positions of the positioning points of the circuit board, and judging whether each LED is misplaced by a result of the comparison; and
an adjusting unit receiving the result of the comparison from the processing unit, and adjusting the position of an LED if the result of the comparison indicates that the LED is deviated from its predetermined mounting position on the circuit board.

2. The mounting machine of claim 1, wherein the sensor is an image sensor with a magnification ranges from 50 times magnification to 100 times magnification.

3. The mounting machine of claim 1, wherein the sensor receives an adjusting result from the adjusting unit and then transmits the adjusting result to the processing unit to decide whether the adjustment of the LED needs to be continued.

4. The mounting machine of claim 3, wherein the sensor obtains a series of images of the LED when the adjusting unit adjusts the position of the LED, and transmits the images to the processing unit, the processing unit controlling the working condition of the adjusting unit according to the images.

5. The mounting machine of claim 1, wherein the optical identification point is arranged on a top surface of each of the LEDs.

6. The mounting machine of claim 1, wherein the circuit board comprises two positioning points arranged on two opposite ends thereof.

7. The mounting machine of claim 6, wherein if the optical identification point of an LED and the two positioning points of the circuit board are in a straight line, the position of the LED does not need to be adjusted by the adjusting unit.

8. The mounting machine of claim 7, wherein if the optical identification point of the LED and the two positioning points of the circuit board are not in a straight line, the adjusting unit adjusts the position of the LED until the optical identification point of the LED and the two positioning points of the circuit board are in a straight line.

9. The mounting machine of claim 1 further comprising a conveyer for transferring the circuit board through the mounting area and the precise adjusting area.

10. The mounting machine of claim 1, wherein the sensor is an optical sensor.

11. The mounting machine of claim 10, wherein the sensor is a charge-coupled device (CCD).

12. The mounting machine of claim 1, wherein the adjusting unit comprises a step motor.

13. The mounting machine of claim 1, wherein the adjusting unit comprises a piezoelectric driver.
